(19) United States
(12) Patent Application Publication
(10) Pub. No.: US 2008/0224082 A1
(43) Pub. Date: Sep. 18, 2008

(54) Valves

(76) Inventor: Richard Warby, Wisbech (GB)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/793,359

(22) PCT Filed: Dec. 15, 2005
(86) PCT No.: PCT/GB2005/004830

§ 371 Date: May 2, 2008

(30) Foreign Application Priority Data
Dec. 15, 2004 (GB) 0427463.5

(51) Int. Cl. F16K 1/00

(52) U.S. Cl. 251/331

(57) ABSTRACT

A valve (10) for use with a dispensing container. The valve comprises a valve stem (11), a valve body (14) and one or more seals (17, 18), the valve stem being slidable within the valve body, the one or more seals co-operating with the valve stem for regulating discharge of fluid. The vale further comprises a sealing gasket (16) for sealing the valve (10) to a dispensing container, in which the one or more seals is/are formed from a first material and the sealing gasket is formed from a second material different from the first material, wherein the sealing gasket is formed from a material comprising butyl or EPDM and the one or more seals is/are formed from a material comprising EPDM or Butyl.

This invention relates to valves suitable for use with dispensing apparatus and to improvements in seals and gaskets for said valves. Further, the invention relates to combinations of valves and dispensing containers.

Prior art valves, attached to dispensing containers, often suffer from ingress of moisture to the container, which can causes contamination or spoiling of the product in the dispensing container. In some circumstances, it is the overall design of the valve and the manner in which the valve is attached to the dispensing container that allows ingress of moisture to the dispensing container. However, the seals and gaskets—which are essentially provided to seal together parts of the dispensing container and the valve—often allow some ingress of moisture.

In particular, non-aqueous suspension formulations for metered dose inhalers (MDIs) containing drug products such as salbutamol, are susceptible to coarsening of the particle size of the drug and caking of the drug on internal surfaces of the canister and valve, owing to the ingress of moisture, while the inhaler is stored.

In the case of MDI solution formulations containing therapeutics such as beclomethasone dipropionate, these therapeutics are susceptible to crystallisation of the drug and/or corrosion of the canister/valve because of moisture ingression while the MDI is stored.

Further, MDI formulations containing drugs such as formoterol, can show greater drug degradation because of moisture ingression into the inhaler while it is stored.

Under hot and humid conditions, the problem of the ingress of moisture into dispensing containers is, generally, more pronounced.

There is, therefore, a need for a valve that minimises the ingress of moisture into a dispensing container, while the container is stored. In an object, the present invention seeks to provide improved seals and gaskets which substantially prevent, or at least reduce, ingress of moisture to the dispensing container.

Accordingly, the invention provides a valve for use with a dispensing container, the valve comprises a valve stem, a valve body and one or more seals, the valve stem being slidable within the valve body, the one or more seals co-operating with the valve stem for regulating discharge of fluid, the valve further comprises a sealing gasket for sealing the valve to a dispensing container, in which the one or more seals are formed from a first material and the sealing gasket is formed from a second material different from the first material, wherein the first and second materials comprise EPDM, butyl, nitrile or polychloroprene.

Preferably, a second seal, or subsequent seal, is formed from a material comprising EPDM, butyl, nitrile or polychloroprene.

The first and second seals may be formed from the same material or, alternatively, from different materials.

Most preferably, the sealing gasket can be formed from a material comprising butyl or EPDM and the one or more seals can be formed from a material comprising EPDM or butyl.

In an alternative, the sealing gasket may be formed from a material comprising EPDM or nitrile and the one or more seals may be formed from a material comprising nitrile or EPDM.

In a further alternative, the sealing gasket may be formed from a material comprising nitrile or butyl and the one or more seals may be formed from a material comprising butyl or nitrile.

It has been found that by utilising a combination of seal types the ingress of moisture into the container is minimised without a loss in performance of the valve.

Further, using a combination of valve seal materials optimises the compatibility of the seals and the product contained in the container, especially the compatibility of the drug substance and the seal materials.

It has been found that the valves of the present invention provide good stability of the dispensing containers upon storage of the containers in various climatic conditions, for example, hot and humid conditions.

The sealing gasket is defined as being static, in that it seals between non-moving parts of the valve, for example, between the valve itself and the container and/or a crimped ferrule.

The one or more seals are defined as being dynamic, in that it or they seal between moving parts of the valve. As such, the one or more seals can be mounted on the valve body or the one or more seals can be mounted on the valve stem. Further alternatively, the first seal can be mounted on the valve body and the second seal may be mounted on the valve stem.

The valve of the present invention may be used as a continuous spray valve or may further comprise a metering chamber, and be a metering valve.

The metering chamber of the metering valve may be permanent or temporary.

When the metering chamber is permanent, the metering chamber is constructed wholly from rigid components, such as components formed from one or more materials comprising polyester, nylon, acetal, or the like, stainless steel, ceramics, glass, or the like. Further, the metering chamber may have no moving parts.

When the metering chamber is temporary, the metering chamber is only defined upon actuation of the metering valve.

The present invention also includes a valve substantially as herein described, with reference to, or as shown in, the accompanying drawings.

In a second aspect of the present invention, there is provided a dispensing container comprising a valve of the present invention and a container for product to be dispensed, the valve being fixed to the container.

The dispensing container may be a pressurised dispensing container, which further contains a propellant.

Preferably, the dispensing container is provided with a closure, in the form of a ferrule crimped over the valve and/or the container, to retain the valve in position on the container. Preferably, the ferrule is formed from stainless steel.

The present invention also includes a dispensing container substantially as herein described, with reference to, or as shown in, the accompanying drawings.

In the following description and claims “inner” and “outer” are used to describe relative positions of components of the valve which are respectively further from or nearer to an outer end 19 of the valve stem 11,102, as shown in the Figures.

The valve may be for use in a pharmaceutical dispensing device, such as, for example, a pulmonary, nasal, or sub-lingual delivery device. A preferred use of the valve is in a pharmaceutical metered dose aerosol inhaler device. The term pharmaceutical, as used herein, is intended to encompass any pharmaceutical, compound, composition, medicament, agent or product which can be delivered or administered to a human being or animal, for example, pharmaceuticals, drugs, biological and medicinal products. Examples include antiallergics, analgesics, bronchodilators, antihistamines, therapeutic proteins and peptides, antitussives, anginal preparations, antibiotics, anti-inflammatory preparations, hormones, or sulfonamides, such as, for example, a vasoconstrictive amine, an enzyme, an alkaloid, or a steroid, including combinations of two or more thereof. In particular, examples include isoproterenol [alpha-(isopropylaminomethyl) protocatechuyl alcohol], phenylephrine, phenylpropanolamine, glucagon, adrenochrome, trypsin, epinephrine, ephedrine, narcotine, codeine, atropine, heparin, morphine, dihydromorphinone, ergotamine, scopolamine, methapyrilene, cyanocobalamin, terbutaline, rimiterol, salbutamol, flunisolide, colchicine, pirbuterol, beclomethasone, orciprenaline, fentanyl, and diamorphine, streptomycin, penicillin, procaine penicillin, tetracycline, chlorotetracycline and hydroxytetracycline, adrenocorticotropic hormone and adrenocortical hormones, such as, cortisone, hydrocortisone, hydrocortisone acetate and prednisolone, insulin, cromolyn sodium, and mometasone, including combinations of two or more thereof.

The pharmaceutical may be used as either the free base or as one or more salts conventional in the art, such as, for example, acetate, benzenesulphonate, benzoate, bircarbonate, bitartrate, bromide, calcium edetate, camsylate, carbonate, chloride, citrate, dihydrochloride, edetate, edisylate, estolate, esylate, fumarate, fluceptate, gluconate, glutamate, glycollylarsanilate, hexylresorcinate, hydrobromide, hydrochloride, hydroxynaphthoate, iodide, isethionate, lactate, lactobionate, malate, maleate, mandelate, mesylate, methylbromide, methylnitrate, methylsulphate, mucate, napsylate, nitrate, pamoate, (embonate), pantothenate, phosphate, diphosphate, polygalacturonate, salicylate, stearate, subacetate, succinate, sulphate, tannate, tartrate, and triethiodide, including combinations of two or more thereof. Cationic salts may also be used, for example, the alkali metals, e.g. Na and K, and ammonium salts and salts of amines known in the art to be pharmaceutically acceptable, for example glycine, ethylene diamine, choline, diethanolamine, triethanolamine, octadecylamine, diethylamine, triethyla-mine, 1-amino-2-propanol-amino-2-(hydroxyl-methyl)propane-1,3-diol, and 1-(3,4-dihydroxyphenyl)-2 isopropylamino-ethanol.

The pharmaceutical will typically be one which is suitable for inhalation and may be provided in any suitable form for this purpose, for example, as a solution or powder suspension in a solvent or carrier liquid, for example, ethanol, or isopropyl alcohol. Typical propellants are HFA134a, HFA227, di-methyl ether and hydrocarbons, such as, butane.

The pharmaceutical may, for example, be one which is suitable for the treatment of asthma. Examples include salbutamol, beclomethasone, salmeterol, fluticasone, formoterol, terbutaline, sodium chromoglycate, budesonide and flunisolide, and physiologically acceptable salts (for example salbutamol sulphate, salmeterol xinafoate, fluticasone propionate, beclomethasone dipropionate, and terbutaline sulphate), solvates and esters, including combinations of two or more thereof. Individual isomers, such as, for example, R-salbutamol, may also be used. As will be appreciated, the pharmaceutical may comprise of one or more active ingredients, an example of which is flutiform, and may optionally be provided together with a suitable carrier, for example a liquid carrier. One or more surfactants may be included if desired.

Embodiments of the present invention will now be described, by way of example only, with reference to the accompanying drawings, in which:

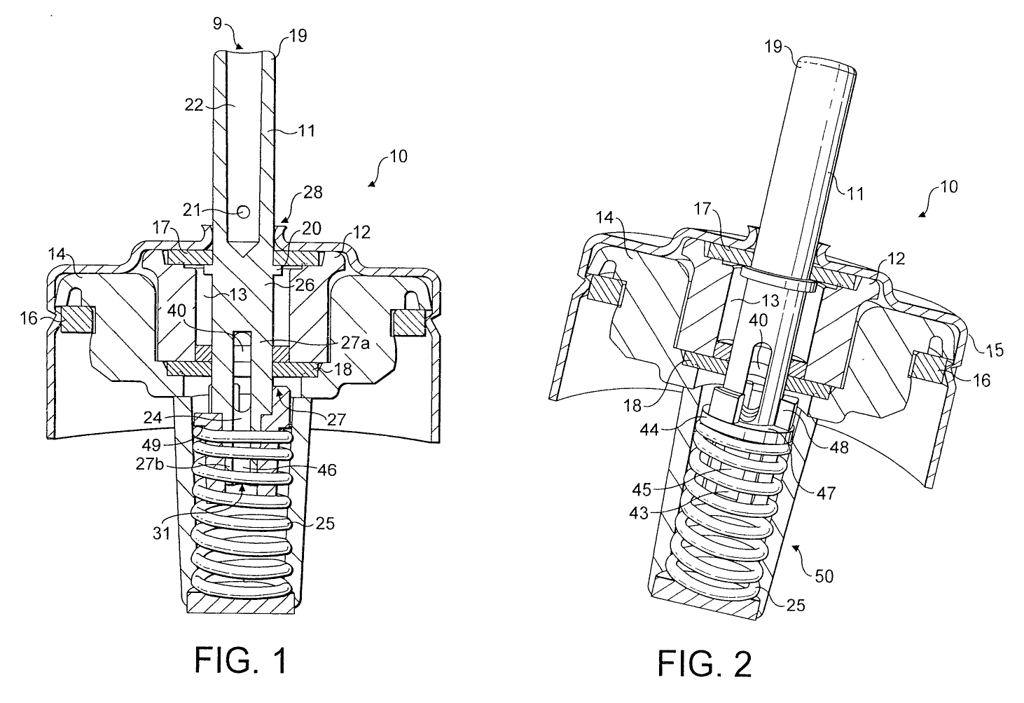

FIG. 1 is a cross-sectional view of a first embodiment of valve according to the present invention in a non-dispensing position;

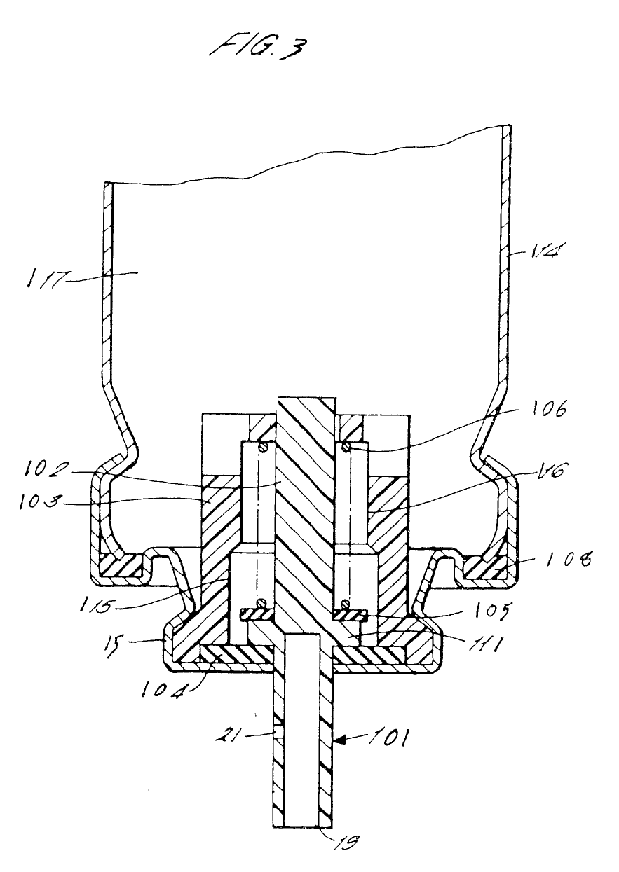

FIG. 2 is a partial cross-sectional view of the valve of FIG. 1 with certain internal components, shown in perspective view; and

FIG. 3 is a cross-sectional view of a second embodiment of valve according to the present invention, shown in a non-dispensing position.

FIGS. 1 and 2 show a first embodiment of valve according to the present invention. The valve 10 includes an elongated valve stem 11 which protrudes from and is axially slidable within a chamber body 12, the chamber body 12 and valve stem 11 defining therebetween an annular metering chamber 13. The chamber body 12 is located within a valve body 14 which is positioned within a pressurised container containing a product to be dispensed. The valve 10 is a metering valve and is held in position with respect to the container by means of a ferrule 15 which is crimped to the top of the container. The ferrule may be anodised aluminium or stainless steel. Sealing between the valve body 14 and container is provided by a static seal in the form of an annular gasket 16. The ferrule 15 has an aperture 28 through which an outer section 19 of the valve stem 11 protrudes. Preferably, the gasket is made from a material comprising EPDM, butyl, nitrile or polychloroprene.

A pair of dynamic seals 17,18 of an elastomeric material, preferably EPDM, butyl, nitrile or polychloroprene, extend radially between the valve stem 11 and the chamber body 12. The “outer” seal 17 is radially compressed between the chamber body 12, valve stem 11 and ferrule 15 so as to provide positive sealing contact to prevent leakage of the contents of the metering chamber 13 between the valve stem 11 and the aperture 28. The compression is achieved by using a seal which provides an interference fit on the valve stem 11 and/or by the crimping of the ferrule 15 onto the pressurised container during assembly. The “inner” seal 18 is located between chamber body 12 and valve body 14 to seal an “inner” end of the metering chamber 13 from the container contents when the valve is in a dispensing position.

The outer section 19 of the valve stem 11 comprises the discharging end of the valve stem 11 and protrudes from the ferrule 15. The outer section 19 comprises a hollow section 22 with an open upper end 9. The hollow section 22 is closed off within the valve by a solid mid-section 26 of the valve stem 11. The hollow section 22 includes a discharge port 21 extending radially through the side wall of valve stem 11.

A radially-extending flange 20 is provided on the mid-section 26 of the valve stem, located within the confines of the metering chamber 13.

An inner section 27 of the valve stem 11 extends inwardly from the solid mid-section 26 and comprises a hollow section having a central passage 24 in the form of a bore with an open inner end 31 which communicates with an interior of the valve body 14. The inner section 27 has a stepped outer profile. An upper portion 27a of the inner section 27 has an outer diameter equal to the outer diameter of the solid mid-section 26. A lower portion 27b of the inner section 27 has a smaller outer diameter such that the inner section 27 undergoes a step change in diameter between the two portions 27a and 27b.

Two elongated slots 40 are formed in the upper portion 27a of the inner section 27. The slots 40 are oriented along the long axis of the valve stem 11 and extend from the solid mid-section 26 to the step change in diameter of the inner section 27. The slots 40 extend radially through the thickness of the wall of the upper portion 27a allowing fluid communication between the central passage 24 and outside the valve stem 11, via the slots 40. The slots 40 are located diametrically opposite one another as best shown in FIG. 2. The slots have a width of 1.00 mm and a length (along the axis of the valve stem 11) of approximately 4.20 mm. The central passage 24 of the inner section 27 of the valve stem 11 preferably has an internal diameter equal to the width of the slots 40, in the example shown 1.00 mm.

The valve stem 11 further comprises a stem base 45 which is received on the end of the inner section 27. The stem base 45 comprises a cylindrical portion 43 with a central bore 46 in which the inner portion 27b of the inner section 27 is received as a sliding fit. The stem base 45 further comprises a flange 44 having an upper face 47 which, on assembly of the valve, abuts a shoulder 51 formed at the step change in diameter of the inner section 27. Three projections 48 extend upwardly from the upper face 47 into proximity with the undersurface of the inner seal 18 and surround the upper portion 27a of the inner section 27. Preferably, the distal ends of the projections are spaced from the underside of the inner seal 18 by between 0.3 and 0.5 mm when the valve stem 11 is in the non-dispensing position. Openings are located between the three projections 48 such that the top of the stem cap 45 has a castellated appearance. The openings allow unimpeded access for fluid flow into and out of the openings 40. The projections 48 restrain lateral movement of the upper portion 27. In addition, the projections 48 act to realign the inner seal 18 during actuation of the valve 10. During movement of the valve stem 11 into the dispensing position there is a tendency for the inner seal 18 to be dragged inwards, out of the plane of the seal, due to the friction between the seal's inner diameter and the valve stem surface. This is a particular problem early in the life of a valve when the seal 18 is relatively new. Uncorrected, this movement of the seal 18 has the ability over time and many actuations of the valve to create variations in the volume of the metering chamber 13 and hence the dose dispensed. The projections 48 alleviate the problem by contacting and pushing back the inner seal 18 on each movement of the valve stem 11 into the non-dispensing position.

A spring 25 extends between the valve body 14 and an undersurface 49 of the flange 44 of the stem base 45 to bias the valve stem 11 into the non-dispensing position, as shown in FIG. 1, in which the flange 20 is held in sealing contact with the outer seal 17.

In this position, the metering chamber 13 is sealed from the atmosphere by the outer seal 17, and can communicate with the bulk storage volume of the pressurised container to which the valve 10 is attached via the slots 40, open end 31 and the central passage 24. Fluid is prevented from by-passing the central passage 24 because of the sealing of the inner seal 18 against the valve stem 11.

Thus, on inversion of the metering valve, so that the outer end 19 of the valve stem 11 is lowermost, the metering chamber 13 will be rapidly charged with liquefied product to be dispensed. It will be noted that the liquefied product can pass from the bulk storage volume of the dispensing container into the valve body 14 via slits 50 formed in the inner part of the valve body 14 as best shown in FIG. 2. On inversion, the metering chamber 13 will initially be filled by gaseous propellant vapour which must be displaced to allow the liquefied product to fill the chamber 13. Liquefied product can flow into the central passage 24 via the slots 40 and the open end 31. The combination of these points of entry for fluid flow has been found to produce excellent displacement of the propellant vapour in the metering chamber 13 and hence excellent filling performance. It is believed that the open end 31 of the central passage 24 creates a jet of fast moving liquid which mixes with and disturbs the liquid-vapour interface in the central passage 24 in the region of the junction between the slots 40 and the inner seal 18. This turbulent action of the jet is believed to decrease the flow restriction at this point leading to better displacement of the propellant vapour.

To actuate the metering valve the valve stem 11 is depressed relative to the valve body 14 such that the valve stem 11 slides axially relative to the chamber body 12. Upon depression of the valve stem 11, the slots 40 slide relative to the inner seal 18 and are closed off by the inner seal 18 thereby isolating the metering chamber 13 from the contents of the valve body 14 and pressurised dispensing container. Upon further movement of the valve stem 11 in the same direction into a dispensing position, the discharge port 21 passes through the outer seal 17 into communication with the metering chamber 13. In this dispensing position, the liquefied product in the metering chamber 13 rapidly boils off and is thus discharged to the atmosphere via the discharge port 21, hollow section 22 and outer end 19.

When the valve stem 11 is released, the biasing of the return spring 25 causes the valve stem 11 to return to its original, non-dispensing position. In normal use, the apparatus is often turned upright for storage before the next actuation. The presence of the open end 31 and slots 40 allows for rapid draining of the metering chamber 13. Further details of this kind of valve arrangement can be found in co-pending application GB 0419093.0.

In an alternative embodiment, as shown in FIG. 3, the claimed one or more seals and gasket made from materials comprising EPDM, butyl, nitrile or polychloroprene can be utilised in valves 101 having the outer seal 104 located in the usual manner—closing off an open end of the valve body 103—and the inner seal 105 located on the valve stem 102 within the valve body 103. In such an arrangement, the valve body 103 is provided with a clearance between the outer surface of the inner seal 105 and the inner surface of the valve body 103, which provides a path for formulation 117 to enter a chamber within the valve body 103, when the valve 101 is in a rest position—as provided by a spring 106 urging the valve stem 102 against the outer seal 104. Through movement of the valve stem 102 against the spring 106, the inner seal 105 is caused to engage part of the valve body 103 to define a temporary metering chamber between the inner and outer seals, such that, further depression of the valve stem 102 allows the product 17 to flow from the metering chamber.

Further, the valve body 103 may be of stepped configuration where the inner seal is located within a larger diameter portion 115 of the valve body 103 in its rest position, and slidably engaging a smaller diameter portion 116 to form the metering chamber. Preferably, the inner seal 105 is a disc-like seal surrounding and extending from the valve stem 102. In addition, the valve stem may be provided with a flange 111, to support the inner seal 105.

A gasket 108 is provided for sealing the valve 101 to a container 104.

Other parts of the valve 101 which are similar to correspondingly numbered parts of the valves of FIGS. 1 and 2, are provided with like reference numbers, and are not discussed further in any detail.

Additional details of this kind of valve configuration can be found in International Patent Application PCT/GB2004/000486.

Although only two examples of suitable valves have been shown in the drawings and described in detail incorporating the one or more seals and gasket of the present invention, it is believed that the concept is equally applicable to practically all types of valves suitable for use with dispenser containers.

It has been found that by utilising a combination of seal types, for example, a valve having a butyl gasket and an EPDM outer seal, the ingress of moisture into the container is minimised without a loss in performance of the valve.

Further, using a combination of valve seal materials optimises the compatibility of the seal and the product contained in the container, especially the compatibility of the drug substance and the seal materials.

It has been found that the valves of the present invention provide good stability of the inhalers upon storage of the inhalers in various climatic conditions, for example, hot and humid conditions.

Further advantageously, the ‘purity profile’ of the active formulation can be increased by reducing the amount of leachables which enter the active formulation. This can be achieved by providing the valve with one or more inner seals made from a selected elastomer which has the lowest possible extractibles, as valve seats of the inner seals are in direct contact with the active formulation, unlike the gaskets, where only the inner surfaces of the gasket are in contact with the formulation.

1. A valve for use with a dispensing container, the valve comprises a valve stem, a valve body and one or more seals, the valve stem being slidable within the valve body, the one or more seals co-operating with the valve stem for regulating discharge of fluid, the valve further comprises a sealing gasket for sealing the valve to a dispensing container, in which the one or more seals are formed from a first material and the sealing gasket is formed from a second material different from the first material, wherein the first and second materials comprise EPDM, butyl, nitrile or polychloroprene.

2. A valve as claimed in claim 1, wherein a second seal, or subsequent seal, is formed from a material comprising EPDM, butyl, nitrile or polychloroprene.

3. A valve as claimed in claim 2, wherein the first and second seals are formed from the same material.

4. A valve as claimed in claim 2, wherein the first and second seals are formed from different materials.

5. A valve as claimed in any preceding claim, wherein the sealing gasket is formed from a material comprising butyl or EPDM and the one or more seals are formed from a material comprising EPDM or butyl.

6. A valve as claimed in any of claims 1 to 4, wherein the sealing gasket is formed from a material comprising EPDM or nitrile and the one or more seals are formed from a material comprising nitrile or EPDM.

7. A valve as claimed in any of claims 1 to 4, wherein the sealing gasket is formed from a material comprising nitrile or butyl and the one or more seals are formed from a material comprising butyl or nitrile.

8. A valve as claimed in any preceding claim, wherein the sealing gasket is defined as being static, in that it seals between non-moving parts of the valve.

9. A valve as claimed in any preceding claim, wherein the one or more seals are defined as being dynamic, in that it or they seal between moving parts of the valve.

10. A valve as claimed in any preceding claim, wherein the one or more seals are mounted on the valve body.

11. A valve as claimed in any preceding claim, wherein the one or more seals are mounted on the valve stem.

12. A valve as claimed in claim 10, wherein the first seal is mounted on the valve body and the second seal is mounted on the valve stem.

13. A valve as claimed in any preceding claim, wherein the valve is a continuous spray valve.

14. A valve as claimed in any of claims 1 to 12, wherein the valve further comprises a metering chamber, and the valve is a metering valve.

15. A valve as claimed in claim 14, wherein the metering chamber of the metering valve is permanent.

16. A valve as claimed in claim 14 or claim 15, wherein the metering chamber is constructed wholly from rigid components, such as components formed from one or more materials selected from polyester, nylon, acetal, or the like, stainless steel, ceramics, glass, or the like.

17. A valve as claimed in any of claims 14 to 16, wherein the metering chamber has no moving parts.

18. A valve as claimed in claim 14, wherein the metering chamber of the metering valve is temporary, and only defined upon actuation of the metering valve.

19. A valve substantially as herein described, with reference to, or as shown in, the accompanying drawings.

20. A dispensing container comprising a valve, as claimed in any preceding claim, and a container for product to be dispensed, the valve being fixed to the container.

21. A dispensing container as claimed in claim 20, wherein the container is a pressurised dispensing container.

22. A dispensing container as claimed in claim 21, wherein the container contains a propellant.

23. A dispensing container as claimed in claim 22, wherein the propellant is selected from HFA 134a and HFA 227.

24. A dispensing container as claimed in any of claims 20 to 23, wherein the container contains a pharmaceutical product comprising salbutamol.

25. A dispensing container as claimed in any of claims 20 to 24, further comprising a closure, in the form of a ferrule crimped over the valve and/or the container, to retain the valve in position on the container, wherein the ferrule is formed from stainless steel.

26. A dispensing container substantially as herein described, with reference to, or as shown in, the accompanying drawings.
